(19) United States
(12) Patent Application Publication
(10) Pub. No.: US 2025/0371298 A1
(43) Pub. Date: Dec. 4, 2025

(54) TECHNIQUE FOR AGGREGATING AND CONVEYING LARGE AMOUNTS OF DATA USING N-DIMENSIONAL SYMBOLIC CODES

(71) Applicant: Auron Industries Group LLC, Howell, NJ (US)

(72) Inventor: Bharat P. Dave, Howell, NJ (US)

(73) Assignee: Auron Industries Group LLC, Howell, NJ (US)

(21) Appl. No.: 19/225,668

(22) Filed: Jun. 2, 2025

Related U.S. Application Data
(60) Provisional application No. 63/655,042, filed on Jun. 2, 2024.

(51) Int. Cl. G06K 7/14; G06K 19/06

(52) U.S. Cl. CPC G06K 7/1417; G06K 19/06037

(57) ABSTRACT

A smart (e.g., electricity) meter receives information (e.g., power consumption data) for different periods of time from set of IOT devices (e.g., electrical appliances), generates symbols (e.g., QR codes) based on the received information, and displays those symbols sequentially and/or in parallel, where each symbol represents a particular set of information for a particular IOT device for a particular period of time. A handheld reader captures images of the displayed symbols and transmits the captured images to a remote server that decodes the imaged symbols to recover the information from the IOT devices for further processing. In this way, a large amount of IOT device information may be efficiently and effectively communicated from the meter to the server using the reader.

### CROSS-REFERENCE TO RELATED APPLICATIONS

This application claims the benefit of the filing date of U.S. provisional application No. 63/655,042, filed on Jun. 2, 2024, the teachings of which are incorporated herein by reference in their entirety.

### BACKGROUND

### Field of the Disclosure

The present disclosure relates to electronics and, more specifically but not exclusively, to meters such as meters for reading electricity usage.

### Description of the Related Art

This section introduces aspects that may help facilitate a better understanding of the disclosure. Accordingly, the statements of this section are to be read in this light and are not to be understood as admissions about what is prior art or what is not prior art.

An electricity meter is an electronic device that measures the amount of electric power consumed at a location, such as a home or business. In order for the utility that provides the electricity to charge the consumer, the utility periodically reads the amount of electric power measured by the electricity meter. This may be accomplished by having an employee of the utility come to the location and read information from the electricity meter using a handheld reader device that wirelessly communicates with the electricity meter. Depending on the situation, the wireless communication between the reader and the meter might not be sufficiently reliable to capture the information accurately. In addition, the amount of information to be read may take a relatively long time to transmit wirelessly from the meter to the reader.

### SUMMARY

Problems in the prior art are addressed in accordance with the principles of the present disclosure by an electricity meter that displays visible symbols, such as QR codes, and a reader that captures images of the displayed symbols, where the symbols encode information conveyed from the meter to the reader, which (i) decodes some or all of the imaged symbols locally and/or (ii) transmits the captured images of the symbols to a remote server, where the imaged symbols are decoded to recover the information for further processing.

In some implementations, the electricity meter is a smart device that communicates with Internet Of Things (IOT) devices at the location, such as different smart appliances, to accumulate time-based information about the electricity usage of those IOT devices. When the smart electricity meter is interrogated by a handheld reader, the meter generates and displays a set of one-or two-dimensional symbols (sequentially and/or serially) that the reader captures images of and further processes (decodes and/or transmits).

The set of symbols generated and displayed by the meter and captured and processed by the reader may include symbols corresponding to different IOT devices, different sets of data for each IOT device, and different time periods. As such, the set of symbols may be considered to constitute a single, multi-dimensional symbol, where two of the dimensions are the length and height of the individual, displayed, two-dimensional symbols, another dimension corresponds to the different IOT devices, another dimension corresponds to different sets of data for a given IOT device, and another dimension corresponds to different times or time periods.

### BRIEF DESCRIPTION OF THE DRAWINGS

Embodiments of the disclosure will become more fully apparent from the following detailed description, the appended claims, and the accompanying drawings in which like reference numerals identify similar or identical elements.

FIG. 1 is a high-level block diagram of a system according to certain embodiments of the present disclosure;

FIG. 2 is a block diagram of the smart meter of FIG. 1, according to certain embodiments;

FIG. 3 is a block diagram of the reader of FIG. 1, according to certain embodiments;

FIG. 4 is a block diagram of the server of FIG. 1, according to certain embodiments;

FIG. 5 is a flow diagram representing processing performed by the system of FIG. 1, according to certain embodiments;

FIG. 6 is a block diagram representing the processing associated with the generation, capture, transmission, and decoding of a single QR code symbol;

FIG. 7 shows an example sequence of 16 different QR codes;

FIG. 8 shows an example set of four different QR codes; and

FIG. 9 is a diagram representing the hierarchical topology of QR codes, according to certain embodiments.

### DETAILED DESCRIPTION

Detailed illustrative embodiments of the present disclosure are disclosed herein. However, specific structural and functional details disclosed herein are merely representative for purposes of describing example embodiments of the present disclosure. The present disclosure may be embodied in many alternate forms and should not be construed as limited to only the embodiments set forth herein. Further, the terminology used herein is for the purpose of describing particular embodiments only and is not intended to be limiting of example embodiments of the disclosure.

As used herein, the singular forms “a,” “an,” and “the,” are intended to include the plural forms as well, unless the context clearly indicates otherwise. It further will be understood that the terms “comprises,” “comprising,” “contains,” “containing,” “includes,” and/or “including,” specify the presence of stated features, steps, or components, but do not preclude the presence or addition of one or more other features, steps, or components. It also should be noted that in some alternative implementations, the functions/acts noted may occur out of the order noted in the figures. For example, two figures shown in succession may in fact be executed substantially concurrently or may sometimes be executed in the reverse order, depending upon the functions/acts involved.

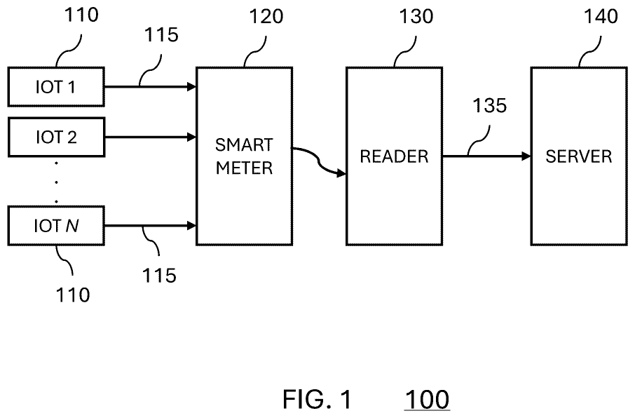

FIG. 1 is a high-level block diagram of a system 100 according to certain embodiments of the present disclosure. As shown in FIG. 1, system 100 includes a smart meter 120 that (i) communicates via wired and/or wireless links 115 with and accumulates information from a set of N IOT devices 110 and (ii) generates and displays visible symbols representing that information. Smart meter 120 is a device that measures energy consumption, organizes and processes the energy data, and reports to the utility company. Smart meter 120 communicates to the server 140 of the utility company via either wired or wireless communication protocols. There are variety of communication mechanisms such as RF communication interface, WiFi interface, Bluetooth interface, GSM interface such as 4G/5G, Narrow Band IOT (NBIOT) interface, etc. Further, smart meter 120 may also connect to smart appliances such as washers, dryers, refrigerators, freezers, cooking ranges, air conditioners, heaters, etc., which are called IOT (Internet Of Things) devices since they have smart, built-in processing as well as the ability to provide and process data via wired or wireless communication mechanisms to the smart meter 120.

System 100 also includes a reader 130 that captures images of those displayed symbols, optionally decodes some or all of those imaged symbols, and transmits via wireless or wireline link 135 some or all of those captured images to a remote server 140, which decodes the imaged symbols and further processes the corresponding recovered information.

In some implementations of system 100, the smart meter 120 is a smart electricity meter, the IOT devices 110 are electric appliances, the displayed visible symbols are QR codes, and the reader 130 is a handheld device used by a utility employee to (i) read the smart meter 120 by capturing images of the displayed QR codes, (ii) optionally decode some or all of the imaged QR codes, and (iii) transmit some or all of the captured images to the utility's remote server 140, which decodes the imaged QR codes to recover and further process the information from the different electric appliances. Those skilled in the art will understand that, in alternative implementations of system 100, the smart meter 120 may be other suitable types of smart meters, such as (without limitation) smart water meters, and the displayed symbols may be other suitable types of one-or two-dimensional symbols, such as (without limitation) one-dimensional bar codes.

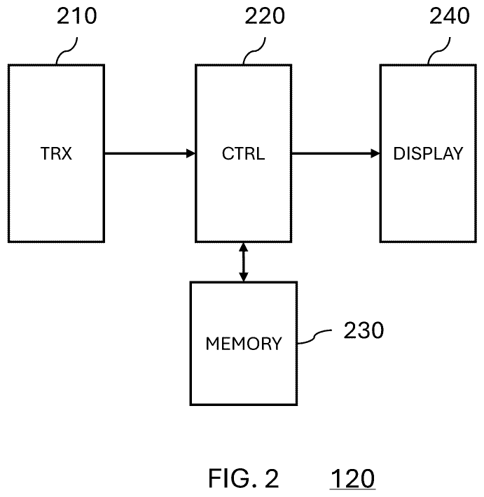

FIG. 2 is a block diagram of the smart meter 120 of FIG. 1, according to certain embodiments. As shown in FIG. 2, the smart meter 120 includes a transceiver (TRX) 210, a controller (CTRL) 220, a memory 230, and a display 240. The transceiver 210 communicates via links 115 with the IOT devices 110 of FIG. 1, the memory 230 stores data, and the display 240 renders the visible symbols. The controller 220, e.g., a central processing unit (CPU) or other suitable processor, controls the operations of the smart meter 120 including the communications of the transceiver 210 to receive information from the IOT devices 110, the storage of that information in the memory 230, the processing and generation of the symbols representing that information, and the rendering of those symbols on the display 240. These symbols are a symbolic code of a set of data. It is to be noted that these symbolic codes can also be transmitted to the utility company's server via wired or wireless communication links.

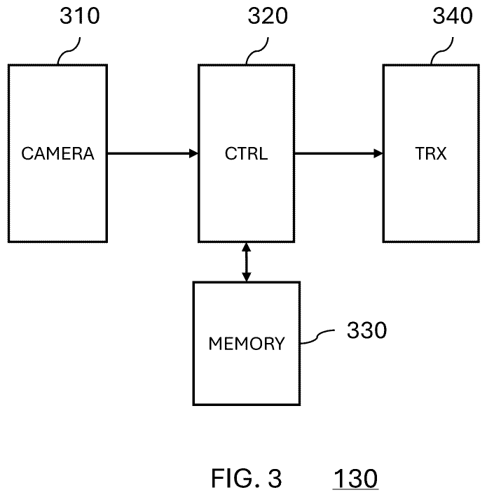

FIG. 3 is a block diagram of the reader 130 of FIG. 1, according to certain embodiments. As shown in FIG. 3, the reader 130 includes a camera 310, a controller 320, a memory 330, and a transceiver 340. The camera 310 captures images of the symbols rendered on the smart meter's display 240 of FIG. 2, the memory 330 stores data, and the transceiver 340 transmits the captured images via link 135 to the server 140 of FIG. 1. The controller 320, e.g., a CPU or other suitable processor, controls the operations of the reader 130 including the capture of images of the displayed symbols by the camera 310, the (optional) decoding some or all of the imaged symbols, the (optional) storage of the corresponding recovered information in the memory 330, and the communication of the transceiver 340 to transmit the captured images to the remote server 140.

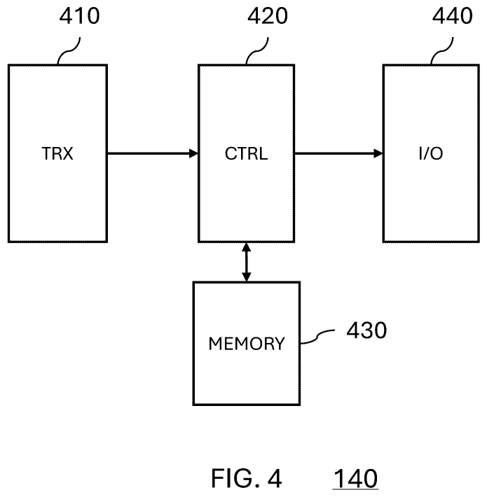

FIG. 4 is a block diagram of the server 140 of FIG. 1, according to certain embodiments. As shown in FIG. 4, the server 140 includes a transceiver 410, a controller 420, a memory 430, and an input/output (I/O) device 440. The transceiver 410 communicates with the reader 130, the memory 430 stores data, and the I/O device 440 communicates with external elements, such as other nodes (not shown) operated by the utility. The controller 420, e.g., a CPU or other suitable processor, controls the operations of the server 140 including the receipt of the captured images from the reader 130, the decoding of the imaged symbols, the storage of the corresponding recovered information in the memory 430, the further processing of the recovered information, and the communication of the recovered information and/or the results of the further processing via the I/O device 440 with the external elements.

In some implementations, each symbol generated and displayed by the smart meter 120 corresponds to a particular set of information from a particular IOT device 110 for a particular time or period of time. Each symbol can also provide a set of information about the smart meter 120 such as type, manufacturer, configuration of the smart meter, measured and processed energy consumption data, alarm status of the smart meter, balance of payment if the smart meter is a pre-paid meter, and hierarchical architecture of how the smart meter is connected to the set of IOT devices 110. For example, in one possible situation, the IOT devices 110 may include a smart refrigerator, a smart dishwasher, a smart washing machine, a smart dryer, a number of different smart television sets, and so on, where each IOT device 110 may report the same or different types of relevant information to the smart meter 120 for different time periods (for example, every 15 minutes of every day), and more than one symbol may be required to represent all of the information for a given time period for a given IOT device 110. Depending on the particular implementation, the smart meter 120 may sequentially render different subsets of one or more different symbols with the reader 130 sequentially capturing images of the one or more displayed symbols displayed side by side on the smart meter's display 240.

As indicated previously, the set of two-dimensional (2D) symbols captured by the reader 130 during a single interrogation session of the smart meter 120 may be considered to be a single, multi-dimensional (nD) symbol, where two of the dimensions correspond to the width and height of each 2D symbol, another dimension corresponds to the different IOT devices 110, another dimension corresponds to different types of information for a given IOT device 110, and another dimension corresponds to different time periods.

A standard 2D QR code is a two-dimensional array of black and white modules made of pixels arranged in a grid. The structure consists of:
Finder patterns that are relatively big squares at corners;
Alignment patterns;
Timing patterns; and
Data modules that form a Mathematically Binary Matrix M∈{0,1}^{m×n}, where each element at row m and column n corresponds to a module.

Each module is identified by a coordinate (x, y) in Z². Data is mapped onto the matrix via encoding schemes such as Reed-Solomon codes with error-correction pattern detection. The finder and alignment patterns are designed using geometric and algebraic properties for localization and decoding.

To extend a 2D QR code to N dimensions M∈{0,1}ⁿ^{₁}^{×n}^{₂}^{× . . . ×N}, where nᵢ is the size of the N-dimensional matrix along the i^{th} dimension. Mathematically, each module is identified by a coordinate (x₁, x₂, . . . , x_{N}) in Z^{N}. Therefore, N-dimensional patterns are extended to hyper-patterns. In particular, a finder hyper-pattern could be a hyper-cube or hyper-sphere positioned at corners. Timing hyper-patterns could be lines or planes with predictable patterns along each axis.

The data modules consist of hyper-volumes encoding the data of the N-dimensional QR code, where the coordinate system is X=(x₁, x₂, . . . , x_{N}) with each xᵢ∈{0, . . . , nᵢ−1} and the encoding function ƒ: Data {0,1}^{x}^{₁}^{×x}^{₂}^{× . . . ×}^{_{N}}.

The processing and analysis of N-dimensional codes requires multi-dimensional processing. Suppose n symbols i₁, i₂, . . . iₙ and each symbol ranges over a set of integers from 1 to N where:

$${\sum }_{{i}_{1} = 1}^{N} {\sum }_{{i}_{2} = 1}^{N} … {\sum }_{{i}_{1} = 1}^{N} f ( {i}_{1} , {i}_{2} , … {i}_{n} ) = {\sum }_{{i}_{1} , {i}_{2} , … {i}_{N}}^{N} f ( {i}_{1} , {i}_{2} , … {i}_{n} )$$

Note that summation occurs over all possible combinations of the indices.

Similarly, for a continuous variable, a multi-dimensional integral is over an N-dimensional domain of R^{N} such that:

$${\int }_{D} f ( {x}_{1} , {x}_{2} , … {x}_{N} ) d {x}_{1} d {x}_{2} … {dx}_{n} = {\int }_{D} f ( x ) dx$$

$$where x = ( {x}_{1} , {x}_{2} , … {x}_{n} ) .$$

Sum over multiple indices

$${\sum }_{{i}_{1} = 1}^{N} {\sum }_{{i}_{2} = 1}^{N} … {\sum }_{{i}_{1} = 1}^{N} f ( {i}_{1} , {i}_{2} , … {i}_{N} )$$

and integrate over multiple variables ƒ_{D}ƒ(x₁, x₂, . . . x_{N})dx₁dx₂ . . . dxₙ. Each iₙ symbol can run over different ranges.

For discrete sums, the limits are often finite such as 1 to N, but they can be (−∞ to ∞). For integrals, the domain D can be a product of intervals D=[a₁×b₁]×[a₂×b₂]× . . . ×[aₙ×bₙ].

An nD symbol may be static or dynamic. In a static nD symbol, the 2D symbols corresponding to the same IOT devices 110 and the same types of information do not vary over time, while the 2D symbols for the same IOT devices 110 and the same types of information do vary over time in a dynamic nD symbol. For example, the 2D symbols representing the configuration of an IOT device 110 might not change from time to time, while the 2D symbols summarizing the consumption of data will typically change over time.

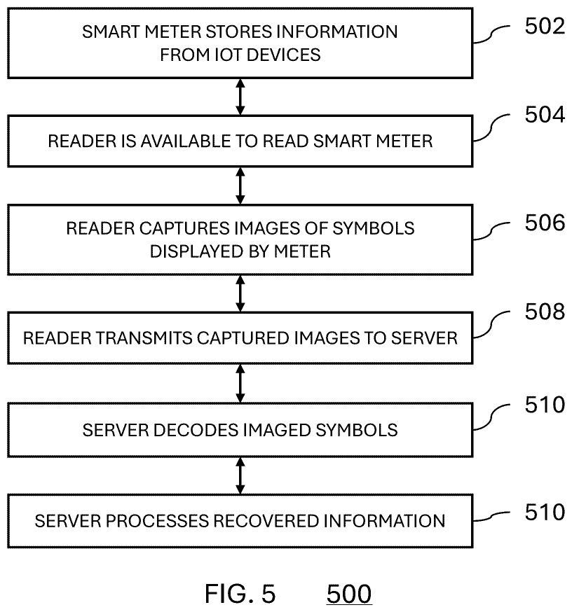

FIG. 5 is a flow diagram representing processing 500 performed by the system 100 of FIG. 1, according to certain embodiments. In step 502, for each time period, the smart meter 120 stores information received from the IOT devices 110 as well as queries the local measurement of the energy consumption, status of alarms from the local in-built sensors. This information is converted into a set of N-dimensional symbols such as QR codes. In step 504, the smart meter 120 determines that the reader 130 is available to read the smart meter 120. In step 506, the smart meter 120 generates a set of symbols corresponding to the accumulated, processed, and summarized data and the stored information from the IOT devices 110 and displays those symbols sequentially and/or in parallel, and the reader 130 captures images of those displayed symbols. In step 508, the reader 130 transmits the captured images to the remote server 140. In step 510, the remote server 140 decodes the imaged symbols in the captured images to recover the information from the IOT devices 110 and, in step 512, the remote server 140 further processes the recovered information and transmits the recovered information and/or the results of that further processing to the external elements.

Those skilled in the art will understand that the implementation of some of the steps shown sequentially in FIG. 5 may overlap in time. Thus, for example, while the smart meter 120 is generating and displaying symbols and the reader 130 is capturing images of those displayed symbols in step 506, the smart meter 120 may continue to receive information from the IOT devices 110 in step 502. Likewise, the processing of steps 506, 508, and 510 may also overlap in time.

Alternatively, in some implementations, the reader 130 captures its images in step 506 and then subsequently transmits those captured images to the server 140 at a different time and from a different location where wireless communications between the reader 130 and the server 140 may be more reliable and less time sensitive.

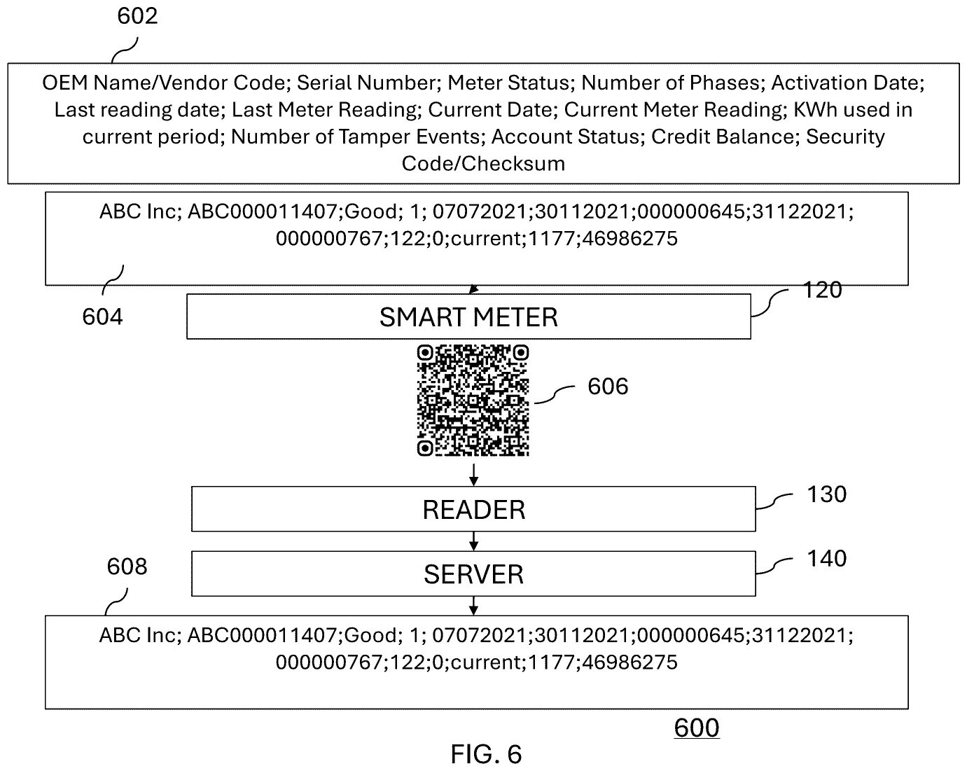

FIG. 6 is a block diagram representing the processing 600 associated with the generation, capture, transmission, and decoding of a single QR code symbol 606 corresponding to a set of information from a single IOT device 110 of FIG. 1 for a single, particular period of time. In FIG. 6, block 602 identifies the different types of information transmitted from the IOT device 110 to the smart meter 120 for each different period of time, and block 604 identifies the particular values for those different types of information for the particular period of time. Note that the information in block 604 is transmitted from the IOT device 110 to the smart meter 120, not the information in block 602. This QR code is for the summary of the information about the smart meter itself.

QR code 606 is the symbol generated and displayed by the smart meter 120 based on the information in block 604 and captured by the reader 130, which transmits the captured image to the server 140, which decodes the imaged symbol to recover the information identified in block 608, which is identical to the information identified in block 604.

In general, the information encoded into a symbol generated and displayed by the smart meter 120 for a given set of information for a given IOT device 110 and a given period of time includes one or more of the following:
The identity of the IOT device 110 (e.g., OEM name/vendor code, serial number);
The types of information (e.g., an ID number that identifies a particular subset of types of information for the IOT device 110);
The period of time (e.g., date and time or an index number that identifies the period of time); and
The values of the identified types of information for the identified IOT device 110 and the identified period of time (e.g., the information in block 604 of FIG. 6).

In addition, in some implementations, the smart meter 120 might also generate and display one or more symbols representing additional information not received from the IOT devices 110. For example, in the context of a smart electricity meter, the additional information may include one or more of the following:
The identity of the smart meter 120;
Configuration of the smart meter 120;
Tamper data indicating whether the smart meter 120 has been tampered with;
Energy consumption;
Date of the last reading and what was the reading of the cumulative power consumption; and
Balance if the smart meter 120 is a pre-paid meter.

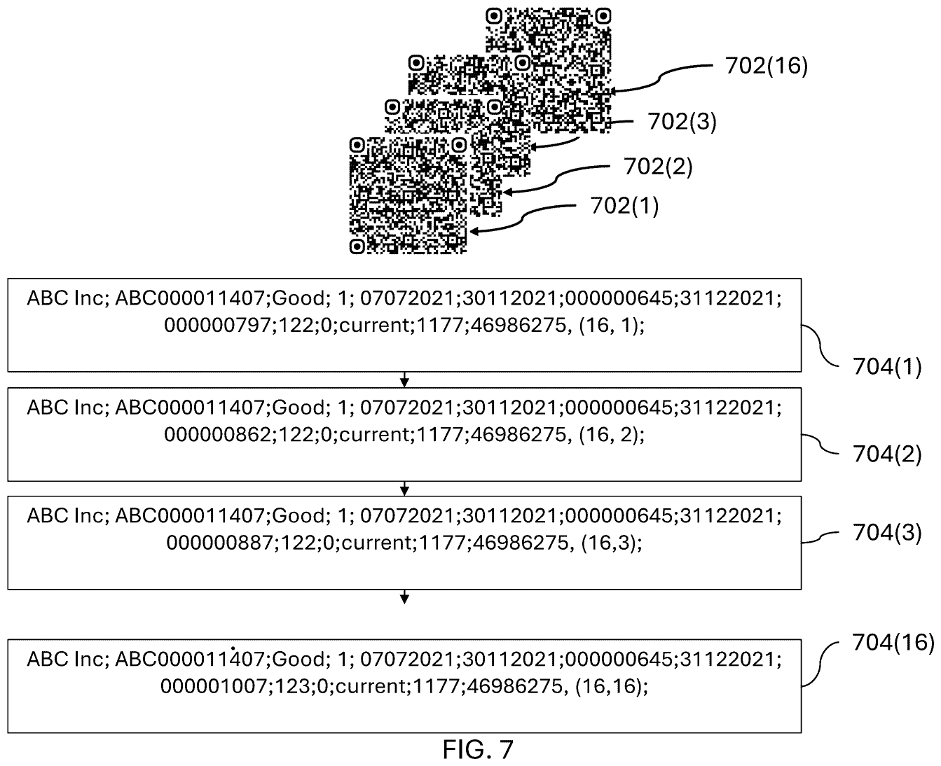

FIG. 7 shows an example sequence of 16 different QR codes 702(1)-702(16) generated and displayed by the smart meter 120 corresponding to 16 different time periods (labeled 1 to 16 of 16) for a single IOT device 110, where blocks 704(1)-704(16) represent the information respectively encoded into the 16 QR codes 702(1)-702(16).

In some implementations, the information encoded into two QR codes for the same types of information for the same IOT device 110 for two consecutive time periods might not be very different. In that case, those two QR codes may be very similar except for a relatively small number of pixels. The smart meter 120 and/or the reader 130 may be designed to take advantage of that similarity by employing inter-symbol QR codes that can reduce the amount of information either encoded into the second symbol displayed by the smart meter 120 or transmitted by the reader 130.

For example, each bit of information encoded into a QR code is represented by a pixel that is either white or black. If the smart meter 120 or the reader 130 determines that the corresponding pixel in the second QR code has not changed from the first QR code, then that pixel can be represented by a white pixel in an inter-symbol QR code either displayed by the smart meter 120 or transmitted by the reader 130 instead of the second QR code. In addition, if the smart meter 120 or the reader 130 determines that the corresponding pixel in the second QR code has changed from the first QR code (i.e., a black pixel is now white, or vice versa), then that pixel can be represented by a black pixel in the inter-symbol QR code. In that case, the server 140 will receive and decode the first QR code as normal. When the server 140 receives and decodes the inter-symbol QR code, it can reconstruct the original second QR code by retaining the previous pixel from the first QR code for each white pixel in the inter-symbol QR code and flipping the previous pixel from the first QR code (i.e., changing a black pixel to white and vice versa) for each black pixel in the inter-symbol QR code.

Depending on how the image data is transmitted from the reader 130 to the server 140, the use of inter-symbol QR codes may greatly reduce the amount of information needed to be transmitted for inter-symbol QR codes that have mostly white pixels and only a relatively few black pixels.

This inter-symbol coding scheme can be continued for additional QR codes as long as the information from one QR code to the next QR code stays sufficiently static. Note that each QR code has a built-in error correction code to ensure error-free transmission of the data.

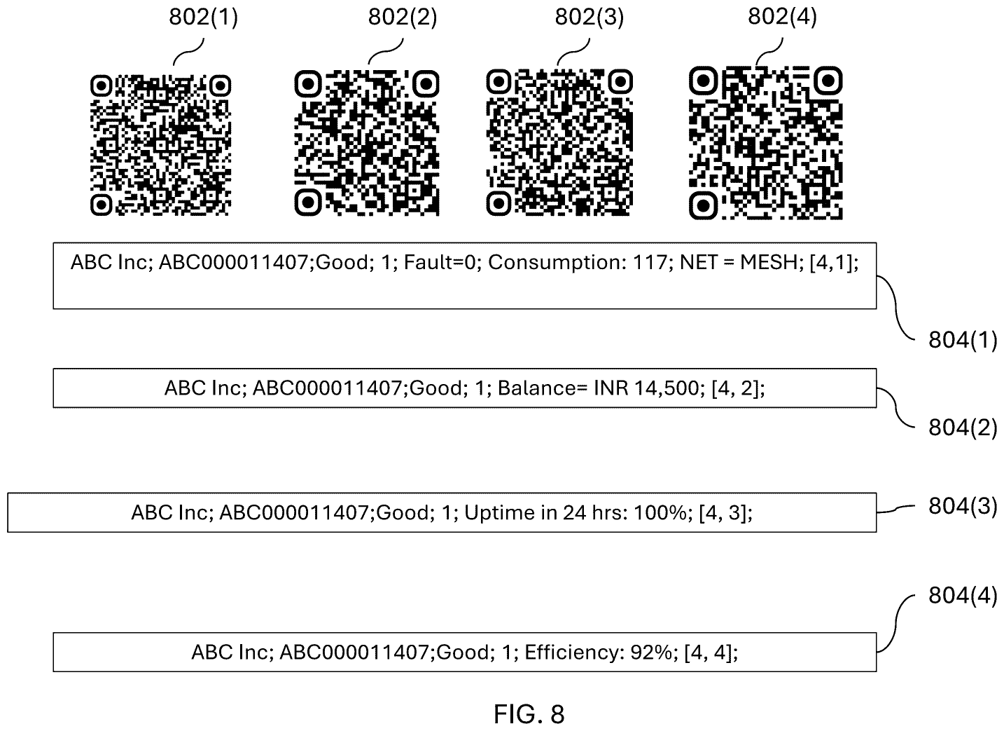

FIG. 8 shows an example set of four different QR codes 802(1)-802(4) representing four different sets of information corresponding to different types of information for a single IOT device 110, where blocks 804(1)-804(4) show the values of those four different sets of information respectively encoded into those four QR codes 802(1)-802(4). In some implementations, the smart meter 120 may display those four QR codes 802 at the same time side by side such that the image captured by the reader 130 includes all four captured QR codes 802.

In some implementations, the information encoded into the symbols by the smart meter 120 and/or the image data transmitted from the reader 130 to the server 140 may be encoded using an appropriate error detection and/or error correction coding scheme, such as a Reed-Solomon Code or other suitable algorithm, to further enhance the reliability and accuracy of the information conveyed from the smart meter 120 to the remote server 140, albeit at the expense of more data being transmitted.

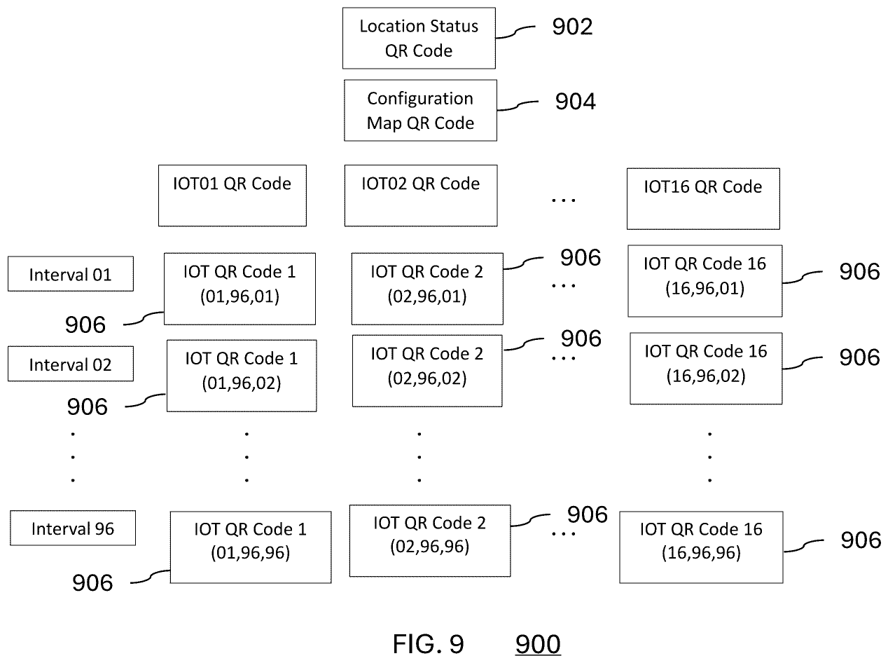

FIG. 9 is a diagram representing the hierarchical topology 900 of QR codes according to certain embodiments. In FIG. 9, the Location Status QR Code 902 is a stand-alone code that provides symbolic representation for a set of data such as the configuration of the smart meter 120, energy consumption, alarm summary data, and sub-tending IOT devices 110. The following is an example of a set of information stored in the Location Status QR Code 902:
[QR Code Type; QR Code Cluster Identifier; QR Cluster Size; QR Code Number in Cluster; Location—GIS Tracking Info; Type of Meter; Vendor; Model Number, Serial Number, Number of Phases; In Service Date; Status; Total Energy Consumption; Energy Consumption since last reading; Last Reading data; Number of Tamper Events since In Service Date; Number of Tamper Events in last 24 hours; Time Interval Designator; Checksum]

The Configuration Map QR Code 904 provides the type and number of smart IOT devices 110 connected to and monitored by the smart meter 120. The following is an example of a set of information stored in the Configuration Map QR Code 904:
[QR Code Type; QR Code Cluster Identified; QR Cluster Size; QR Code Number in cluster; Location—GIST tracking information; Number of IOT Devices; IOT Device1 Type; IOT Device2 Type; IOT Device3 Type; . . . IOT Device 16 Type; Time Interval Designator; Checksum]

Each IOT QR Code 906 is the QR code for an individual IOT device 110 and a different time period. FIG. 9 represents the IOT QR Codes 906 for each of 16 different IOT devices 110 and each of 96 different time periods. The following is an example of a set of information stored in each IOT QR Code 906:
[IOT QR Code; QR Code Cluster Identifier; QR Cluster Size; QR code number in Cluster; Location—GIS Tracking Info; Identifier of IOT device; Type of IOT device; Vendor; Model Number, Serial Number; In Service Data; Status; Total Energy Consumption; Energy Consumption in last 24 hours; Usage patterns; Configuration Parameter 1, Configuration Parameter 2, Configuration Parameter3; . . . ; Configuration Parameter 24; Time Interval Designator; Checksum]

The server 140 may implement data analytics algorithms using the QR code-based hierarchical structures of FIG. 9 to process and analyze the data to assess the consumer usage, community usage, customer buying patterns, plan the load shedding, etc.

The disclosed technique enables a relatively large amount of IOT device data to be conveyed reliably and efficiently from the smart meter 120 to the server 140 using a handheld reader 130 compared to prior-art techniques involving the wireless transmission of data from a meter to a remote server via a handheld reader.

This static and dynamic N-dimensional coding and decoding using symbolic codes can be used not only for smart electricity meters but many other IOT devices such as water meters, gas meters, etc. For example, with water meters, one community water meter is connected to other consumer specific sub-meters. This concept is also applicable to any home automation hub to control, manage, and retrieve a multitude of IOT devices at any location. This concept can also be used in industrial setups where a multitude of smart machines can be connected to the hub and that hub is connected to centralized control center.

A utility company may implement a complex, large, smart grid architecture where many (e.g., thousands or even millions) of smart meters are connected to a centralized server and each smart meter is connected to many smart IOT devices. Such a utility network may have one or more power-distribution transformers in each community, with each community or each transformer having multiple power lines, each of which supporting multiple smart meters and each smart meter monitoring multiple IOT devices, all of which together generate a multitude of data, including performance, error-monitoring, consumption, and fault-isolation data to be generated, processed, and summarized with necessary resulting actions being taken.

As utility grids are getting smart and with many (e.g., millions or even billions) of interconnected smart IOT devices continuously consuming and generating data, a very large hyper-scale database is continuously generated, monitored, and processed. The symbolic codes of this disclosure may be used to query, correlate, and process the data, and then make decisions based on that data. The present disclosure enables complex algorithms to be simplified and provide very rapid computation, processing, and decision-making.

In one example, an architecture has ten spokes (e.g., streets), with each spoke having 10,000 smart meters, for a total of 100,000 meters. If all of the data from each spoke can be summarized into one multi-dimensional QR code, then only ten nD QR codes need to be processed instead of having to process data from 100,000 locations to assess the network and make decisions. For simplicity, assume that three out of ten nD QR codes are showing that there is no power in those three spokes. In that case, a fault-isolation algorithm can be used to analyze and locate the fault and dispatch a technician to resolve the problem. If there is a wide network outage, a decision can be made to prioritize the location list for the restoration sequence. In this situation, each smart meter is a hub for getting information from each home due to the connected smart IOT devices. Now, there are consumer preferences, selections, usage patterns, data, etc., from 100,000 users that can be sold to come up with targeted marketing material. For example, data from a consumer with an old TV model can be used to push a promotion to upgrade the TV. Similarly, if the consumer is not using any home security system or they are using a specific internet service provider, one can mine that data to sell or come up with a marketing plan to address the consumer needs and target product and sales plans accordingly.

A utility company has a Control, Monitor, and Distribution (CMD) unit which measures energy consumptions at various locations throughout the utility energy distribution network. A utility may have a large transformer that serves multiple cities, say City A to City K, where the transformer has a control, monitor and display unit called TRCMDi at the i^{th} location of the transformer and generates the QR code QRTRCMDi to summarize the transformer status, power distribution, and consumption by measuring power at each of the city-level control distribution and monitor units, called CCMDA at city A.

A main transformer is connected to city-level CCMDj from City A to City K. Each CCMDj provides the QR code QRCCMDj which provides status, power distribution, and consumption statistics. Each city-level CCMDj connects N different street-level SCMDn which provides the QR Code QRSCMDn for status, power distribution, and consumption statistics. Each street-level CCMDn connects to M different consumer meters and each consumer meter provides the various QR codes for that location. Each consumer meter is connected to J different IOT devices, and each IOT device provides the information of the IOT devices to its consumer meter.

Each location up to consumer-meter level generates and sends one or more static or dynamic QR codes to the centralized network server. Each QR code is identified by the QR code type and the network server matches it with the specific template in the database at the network server. The network server uses the QR codes received from different locations and extracts the information and populates the database accordingly.

A technician scans the QR code from each of the consumer, street-level, city-level, and transformer from respective distribution, control, and monitoring units and transmits to the centralized network server. The network server receives and decodes each QR code, identifies the template associated with the location, and populates the associated database entry accordingly after going through error detection and correction steps.

The network server evaluates the QR code and identifies any fault by processing series of hierarchical QR codes received from different locations, correlates the data, and derives the status and fault isolation of the utility distribution network. If required, the network server then sends a request to the network support center to dispatch the utility staff to correct the errors.

The network server either processes the QR codes from different locations in native form or applies different algorithms to derive the network topology, network energy consumption, and status of the network. The network server also decodes each QR code and extracts the data and updates the database values of each IOT device. The network server integrates the data from various QR codes and makes decisions required by the network control center.

The disclosure has been described in the context of a smart meter, such as a smart electricity meter, that gathers information, such as power consumption data, from multiple IOT devices, such as smart home appliances, for different time periods, and uses that information to generate and display 2D symbols of a multi-dimensional symbol, such as 2D QR codes of a multi-dimensional QR code, that are imaged using a reader, such as a hand-held reader operated by a utility company employee, where the reader forwards the imaged symbols to a server, such as a utility company server, that decodes the multi-dimensional symbol to recover and further process the original IOT device information. In general, the technique of using multi-dimensional symbolic codes, such as multi-dimensional QR codes, to aggregate and convey large amounts of data can be employed in other suitable situations and applications. In the following claims, the term “meter” is used generically to describe the device the aggregates and conveys the data using multi-dimensional symbolic codes, and the term “reader” is used generically to describe the device that captures images of the displayed 2D symbolic codes that make up a multi-dimensional symbolic code.

In certain embodiments of the present disclosure, a meter comprises a transceiver configured to receive information from one or more devices; a controller configured to generate a plurality of symbols based on the received information; and a display configured to render the plurality of symbols.

In at least some of the above embodiments, the meter is an electricity meter; the one or more devices are a plurality of IOT devices; and the received information corresponds to power consumed by the IOT devices for different periods of time.

In at least some of the above embodiments, each symbol corresponds to a particular set of information for a particular device for a particular period of time; and different symbols correspond to one or more of different sets of information, different devices, and different periods of time.

In at least some of the above embodiments, the symbols are QR codes.

In at least some of the above embodiments, a second displayed symbol is an inter-symbol QR code representing differences between a first QR code and a corresponding second QR code.

In at least some of the above embodiments, at least some of the symbols are displayed sequentially.

In at least some of the above embodiments, at least some of the symbols are displayed in parallel side by side.

In at least some of the above embodiments, the meter is one instance in a network of meters, each of which receives information from a different set of one or more devices, and the network processes data from the different meters to make network-level decisions.

In at least some of the above embodiments, the plurality of symbols are two-dimensional (2D) symbols that are part of a multi-dimensional (ND) symbol, wherein two of the dimensions of the ND symbol correspond to width and height of each 2D symbol, another dimension of the ND symbol corresponds to different devices, and another dimension of the ND symbol corresponds to different time periods.

In at least some of the above embodiments, another dimension of the ND symbol corresponds to different types of information for a given device.

Unless explicitly stated otherwise, each numerical value and range should be interpreted as being approximate as if the word “about” or “approximately” preceded the value or range.

The use of figure numbers and/or figure reference labels in the claims is intended to identify one or more possible embodiments of the claimed subject matter in order to facilitate the interpretation of the claims. Such use is not to be construed as necessarily limiting the scope of those claims to the embodiments shown in the corresponding figures.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence. Likewise, additional steps may be included in such methods, and certain steps may be omitted or combined, in methods consistent with various embodiments of the disclosure.

Reference herein to “one embodiment” or “an embodiment” means that a particular feature, structure, or characteristic described in connection with the embodiment can be included in at least one embodiment of the disclosure. The appearances of the phrase “in one embodiment” in various places in the specification are not necessarily all referring to the same embodiment, nor are separate or alternative embodiments necessarily mutually exclusive of other embodiments. The same applies to the term “implementation.”

Unless otherwise specified herein, the use of the ordinal adjectives “first,” “second,” “third,” etc., to refer to an object of a plurality of like objects merely indicates that different instances of such like objects are being referred to, and is not intended to imply that the like objects so referred-to have to be in a corresponding order or sequence, either temporally, spatially, in ranking, or in any other manner.

Also, for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements. The same type of distinction applies to the use of terms “attached” and “directly attached,” as applied to a description of a physical structure.

As used herein in reference to an element and a standard, the terms “compatible” and “conform” mean that the element communicates with other elements in a manner wholly or partially specified by the standard and would be recognized by other elements as sufficiently capable of communicating with the other elements in the manner specified by the standard. A compatible or conforming element does not need to operate internally in a manner specified by the standard.

The described embodiments are to be considered in all respects as only illustrative and not restrictive. In particular, the scope of the disclosure is indicated by the appended claims rather than by the description and figures herein. All changes that come within the meaning and range of equivalency of the claims are to be embraced within their scope.

The functions of the various elements shown in the figures, including any functional blocks labeled as “processors” and/or “controllers,” may be provided through the use of dedicated hardware as well as hardware capable of executing software in association with appropriate software. Upon being provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and non-volatile storage. Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

It should be appreciated by those of ordinary skill in the art that any block diagrams herein represent conceptual views of illustrative circuitry embodying the principles of the disclosure. Similarly, it will be appreciated that any flow charts, flow diagrams, state transition diagrams, pseudo code, and the like represent various processes which may be substantially represented in computer readable medium and so executed by a computer or processor, whether or not such computer or processor is explicitly shown.

As will be appreciated by one of ordinary skill in the art, the present disclosure may be embodied as an apparatus (including, for example, a system, a network, a machine, a device, a computer program product, and/or the like), as a method (including, for example, a business process, a computer-implemented process, and/or the like), or as any combination of the foregoing. Accordingly, embodiments of the present disclosure may take the form of an entirely software-based embodiment (including firmware, resident software, micro-code, and the like), an entirely hardware embodiment, or an embodiment combining software and hardware aspects that may generally be referred to herein as a “system” or “network”.

Embodiments of the disclosure can be manifest in the form of methods and apparatuses for practicing those methods. Embodiments of the disclosure can also be manifest in the form of program code embodied in tangible media, such as magnetic recording media, optical recording media, solid state memory, floppy diskettes, CD-ROMs, hard drives, or any other non-transitory machine-readable storage medium, wherein, upon the program code being loaded into and executed by a machine, such as a computer, the machine becomes an apparatus for practicing the disclosure. Embodiments of the disclosure can also be manifest in the form of program code, for example, stored in a non-transitory machine-readable storage medium including being loaded into and/or executed by a machine, wherein, upon the program code being loaded into and executed by a machine, such as a computer, the machine becomes an apparatus for practicing the disclosure. Upon being implemented on a general-purpose processor, the program code segments combine with the processor to provide a unique device that operates analogously to specific logic circuits. The term “non-transitory,” as used herein, is a limitation of the medium itself (i.e., tangible, not a signal) as opposed to a limitation on data storage persistency (e.g., RAM vs. ROM).

Signals and corresponding terminals, nodes, ports, links, interfaces, or paths may be referred to by the same name and/or label and are interchangeable for purposes here.

In this specification including any claims, the term “each” may be used to refer to one or more specified characteristics of a plurality of previously recited elements or steps. When used with the open-ended term “comprising,” the recitation of the term “each” does not exclude additional, unrecited elements or steps. Thus, it will be understood that an apparatus may have additional, unrecited elements and a method may have additional, unrecited steps, where the additional, unrecited elements or steps do not have the one or more specified characteristics.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements. For example, the phrases “at least one of A and B” and “at least one of A or B” are both to be interpreted to have the same meaning, encompassing the following three possibilities: 1—only A; 2—only B; 3—both A and B.

All documents mentioned herein are hereby incorporated by reference in their entirety or alternatively to provide the disclosure for which they were specifically relied upon.

The embodiments covered by the claims in this application are limited to embodiments that (1) are enabled by this specification and (2) correspond to statutory subject matter. Non-enabled embodiments and embodiments that correspond to non-statutory subject matter are explicitly disclaimed even if they fall within the scope of the claims.

As used herein and in the claims, the term “provide” with respect to an apparatus or with respect to a system, device, or component encompasses designing or fabricating the apparatus, system, device, or component; causing the apparatus, system, device, or component to be designed or fabricated; and/or obtaining the apparatus, system, device, or component by purchase, lease, rental, or other contractual arrangement.

While preferred embodiments of the disclosure have been shown and described herein, it will be obvious to those skilled in the art that such embodiments are provided by way of example only. Numerous variations, changes, and substitutions will now occur to those skilled in the art without departing from the disclosure. It should be understood that various alternatives to the embodiments of the disclosure described herein may be employed in practicing the technology of the disclosure. It is intended that the following claims define the scope of the invention and that methods and structures within the scope of these claims and their equivalents be covered thereby.

What is claimed is:

1. A meter comprising:
a transceiver configured to receive information from one or more devices;
a controller configured to generate a plurality of symbols based on the received information; and
a display configured to render the plurality of symbols.

2. The meter of claim 1, wherein:
the meter is an electricity meter;
the one or more devices are a plurality of IOT devices; and
the received information corresponds to power consumed by the IOT devices for different periods of time.

3. The meter of claim 1, wherein:
each symbol corresponds to a particular set of information for a particular device for a particular period of time; and
different symbols correspond to one or more of different sets of information, different devices, and different periods of time.

4. The meter of claim 1, wherein the symbols are QR codes.

5. The meter of claim 4, wherein a second displayed symbol is an inter-symbol QR code representing differences between a first QR code and a corresponding second QR code.

6. The meter of claim 1, wherein at least some of the symbols are displayed sequentially.

7. The meter of claim 1, wherein at least some of the symbols are displayed in parallel side by side.

8. The meter of claim 1, wherein:
the meter is one instance in a network of meters, each of which receives information from a different set of one or more devices; and
the network processes data from the different meters to make network-level decisions.

9. The meter of claim 1, wherein the plurality of symbols are two-dimensional (2D) symbols that are part of a multi-dimensional (ND) symbol, wherein two of the dimensions of the ND symbol correspond to width and height of each 2D symbol, another dimension of the ND symbol corresponds to different devices, and another dimension of the ND symbol corresponds to different time periods.

10. A method for the meter of claim 1, the method comprising:
the transceiver receiving information from the one or more devices;
the controller generating the plurality of symbols based on the received information; and
the display rendering the plurality of symbols.

11. The method of claim 10, wherein:
the meter is an electricity meter;
the one or more devices are a plurality of IOT devices; and
the received information corresponds to power consumed by the IOT devices for different periods of time.

12. The method of claim 10, wherein:
each symbol corresponds to a particular set of information for a particular device for a particular period of time; and
different symbols correspond to one or more of different sets of information, different devices, and different periods of time.

13. The method of claim 10, wherein the symbols are QR codes.

14. The method of claim 13, wherein a second displayed symbol is an inter-symbol QR code representing differences between a first QR code and a corresponding second QR code.

15. The method of claim 10, wherein at least some of the symbols are displayed sequentially.

16. The method of claim 10, wherein at least some of the symbols are displayed in parallel side by side.

17. A reader comprising:
a camera configured to capture images of symbols displayed by a meter; and
a transceiver configured to transmit the captured images to a server.

18. The meter of claim 17, further comprising:
a controller configured to generate an inter-symbol QR code representing differences between a first QR code and a corresponding second QR code.

19. A method for the reader of claim 17, wherein:
the camera captures the images of the symbols displayed by the meter; and
the transceiver transmits the captured images to the server.

20. A method for the meter of claim 17, further comprising:
the controller generating the inter-symbol QR code representing the differences between the first QR code and the corresponding second QR code.
